(19) United States
(12) Patent Application Publication
(10) Pub. No.: US 2016/0098620 A1
(43) Pub. Date: Apr. 7, 2016

(54) METHOD AND SYSTEM FOR OBJECT IDENTIFICATION

(71) Applicant: 1626628 Ontario Limited, (US)

(72) Inventor: Wolfhard GEILE, Ottawa (CA)

(73) Assignee: 1626628 ONTARIO LIMITED, Toronto (CA)

(21) Appl. No.: 13/793,053

(22) Filed: Mar. 11, 2013

(51) Int. Cl. G06K 9/62; G06K 9/46; G06T 7/40; G06K 9/32

(52) U.S. Cl. CPC G06K 9/6267; G06K 9/3241; G06K 9/4642; G06T 7/408; G06T 2207/10024; G06T 2207/20021

(57) ABSTRACT

A system and method for object classification is provided. The system includes a computing device that typically comprises a processor configured to receive data and detect an object within the data. Once an object is detected, it can be decomposed into sub-objects and connectivities. Based on the sub-objects and connectivities parameters can be generated. Moreover, based on at least one of sub-objects, connectivities and parameters objective measures can be generated. The object can then be classified based on the objective measures. The parameters can be linked into into linked parameters. Linked classification measures can be generated based on linked parameters. The system can also detect environment objects that form the environment of the detected object. Similar to an object, an environment object can be decomposed into environment sub-objects, and subsequently to environment parameters. Objective measure generation can then be further based on the environment

### BACKGROUND OF THE INVENTION

1. Field of the Invention

The present invention is directed to image processing generally and image classification and object recognition specifically.

2. Description of the Related Art

Object identification based on image data typically involves applying known image processing techniques to enhance certain image characteristics and to match the enhanced characteristics to a template. For example, in edge matching, edge detection techniques are applied to identify edges, and edges detected in the image are matched to a template. The problem with edge matching is that edge detection discards a lot of useful information. Greyscale matching tries to overcome this by matching the results of greyscale analysis of an image to templates. Alternatively, image gradients, histograms, or results of other image enhancement techniques may be compared to templates. These techniques can be used in combination. Alternative methods use feature detection such as the detection of surface patches, corners and linear edges. Features are extracted from both the image and the template object to be detected, and then these extracted features are matched.

The existing techniques suffer from various shortcomings such as inability to deal well with natural variations in objects, for example based on viewpoints, size and scale changes and even translation and rotation of objects. Accordingly, an improved method of object detection is needed.

### SUMMARY OF THE INVENTION

It is an object to provide a novel system and method for object identification that obviates and mitigates at least one of the above-identified disadvantages of the prior art.

According to an aspect, a method of object classification at a computing device can comprise:
receiving data;
detecting an object based on the data;
decomposing the object into sub-objects and connectivities;
generating parameters based on the sub-objects and connectivities; and
generating objective measures based on at least one of the sub-objects, connectivities and parameters.

The method can further comprise classifying the object based on the objective measures The method can further comprise maintaining the parameters, connectivities and sub-objects as a primary multi-dimensional data structure and maintaining the objective measures as a secondary multi-dimensional data structure. The method can also comprise decomposing the sub-objects until each sub-object is a primitive object.

Decomposing can be repeated on the sub-objects for n times where n is an integer >1. The parameters can comprise on one or more of sensory data measures and derived physical measures. The sensory data measures can comprise one or more of tone, texture and gray value gradient. The data can be received from a sensing device. The data can also be received from non-imaging sources. Generating of the objective measures can include determining an occurrence or co-occurrence of sub-objects, parameters and connectivities.

Generating at least one objective measure can further comprise:
linking the parameters into linked parameters; and
generating linked classification measures based on the linked parameters.

Linking can be performed based on the connectivities. The connectivities can include one or more of a spatial, temporal or functional relationship between a plurality of sub-objects. The classification can be based on a rule based association of the objective measures. Generating of the objective measures can include pattern analysis of the parameters.

The method can further comprise:
detecting an environment object based on the data;
decomposing the environment object into environment sub-objects; and
generating environment parameters based on the environment sub-objects.

Generating at least one objective measure can be further based on the environment parameters. The environment sub-objects and the sub-objects can be linked and at least one of the at least one objective measure can be based on the linkage between the sub-objects and the environment sub-objects.

Another aspect provides a computing device for object classification. The computing device typically comprises a processor configured to:
receive
detect an object within the data;
decompose the object into sub-objects and connectivities;
generate parameter based on the sub-objects and connectivities; and
generate objective measures based on at east one of the sub-objects, connectivities and parameters.

The processor can be further configured to classify the object based on the objective measures. The processor can also be configured to decompose the sub-objects until each sub-object is a primitive object. The processor can also be configured to:
generate linked classification measures based on the linked parameters.

The processor can be further configured to:
detect an environment object based on the data;
decompose the environment object into environment sub-objects; and
generate environment parameters based on the environment sub-objects;
wherein the processor is configured to generate the objective measures further based on the environment parameters.

The processor can be further configured to:

maintain said parameters, connectivities and sub-objects as a primary multi-dimensional data structure; and

maintain said objective measures as a secondary multi-dimensional data structure.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a block diagram of an embodiment of a system for object identification;

FIG. 2 shows a flow chart showing a method of object decomposition in accordance with an embodiment;

FIG. 3 shows an example data collection area in accordance with an embodiment;

FIG. 4 shows an example object and sub-objects in accordance with an embodiment;

FIG. 5 shows a flow chart showing a method of object recognition in accordance with an embodiment;

FIG. 6 shows a flow chart showing a method of object recognition in accordance with an embodiment; and

FIG. 7 shows a flow chart showing a method of object recognition in accordance with an embodiment.

### DETAILED DESCRIPTION OF THE PREFERRED EMBODIMENTS

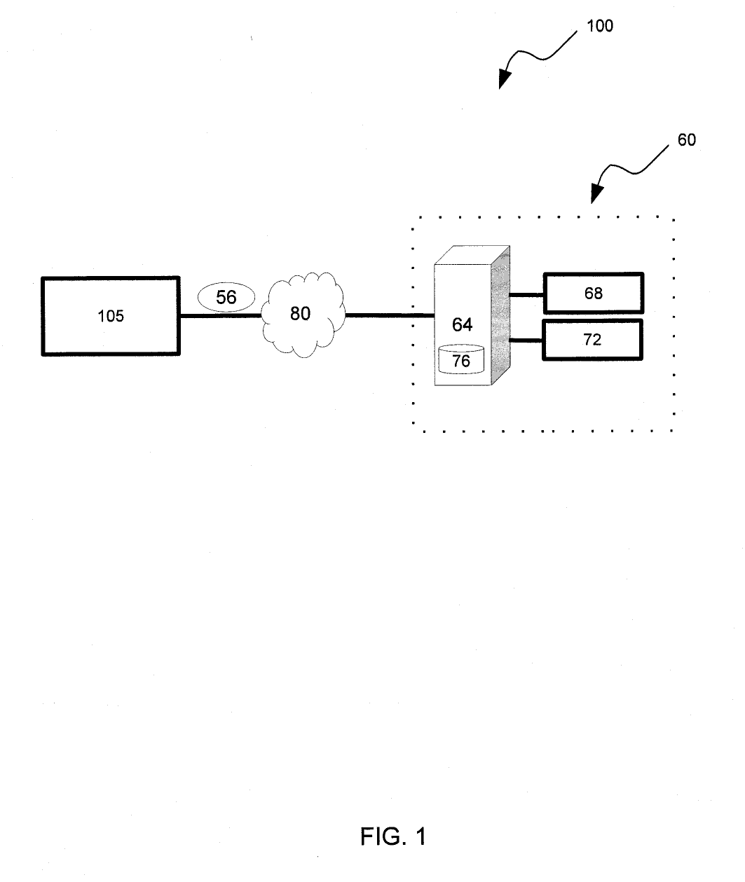

Referring back to FIG. 1, a system for object detection and recognition is shown. System 100 includes a data source or data sources 105 and apparatus 60. Data sources 105 include any sources 105 with which data can be collected, derived or consolidated corresponding to a physical data collection area and the objects and environments contained within it. A source 105 can comprise a sensing device and thus can be any device capable of obtaining data from an area, and accordingly from objects and environments contained within the area. Sensing devices can include electromagnetic sensors (such as photographic or optical sensors, infrared sensors including thermal, ultraviolet, radar, or Light Detection And Ranging (LIDAR)), sound-based sensors such as microphones, sonars and ultrasound, as well as magnetic sensors such as magnetic resonance imaging devices. Other types of sensing devices and respective modalities will now occur to those of skill in the art.

In variations, data corresponding to a data collection area can be obtained from other data sources 105 besides a sensing device. For example, the data can be manually derived to correspond to an area, such as in the case of a drawing or a tracing, or can be represented by any other graphical data, such as data stored within a geo-spatial information system. In other variations, sources producing non-image, non-graphical data, such as an array of measurements taken of area and/or object dimensions or other properties distributed or non-spatially recorded material properties can be used. In other variations, data can be derived from the results of a number of processing steps performed on original data collected. In further variations, data can be derived from statistical or other alphanumerical data stored in an array form that has been derived from real objects. It will now occur to those of skill in the art that there are various other sources of data that can be used with system 100.

A data collection area can be any area, microscopic or macroscopic, corresponding to which data can be collected, derived or consolidated. Accordingly, an area may be comprised of portions of land, sea, air and space, as well as areas within structures such as areas within rooms, stadiums, swimming pools and others. An area may be comprised of portions of a man made structure such as portions of a building, a bridge or a vehicle. An area may also be comprised of portions of living beings such as a portion of an abdomen, or tree trunk, and may include microscopic areas such as a cell culture or a tissue sample.

An area can contain objects and environments surrounding the objects. For example, an object can be any man-made structure or any part or aggregate of a man-made structure such as a building, a city, a bridge, a road, a railroad, a canal, a vehicle, a ship or a plane, as well as any natural structure or any part or aggregate of natural structures such as an animal, a plant, a tree, a forest, a field, a river, a lake or an ocean. An environment can comprise any entities within the vicinity of the object, and comprise any man-made or natural structures, or part or aggregate thereof, such as vehicles, and buildings, infrastructure, or roads, as well as animals, plants, trees forests, fields, rivers, lakes or oceans.

For example, in an embodiment, an object can be one or more machine parts being used in an assembly line, whereas an environment could consist of additional machine parts, portions of the assembly line and other machines and identifiers within the vicinity of the machine parts that comprise the object. In another embodiment, an object can be any part of a body, such as an organ, a bone, a tumor, a cyst, and an environment could comprise of tissues, organs and other body parts within the vicinity of the object. In yet other embodiments, an object can be a cell, a collection of cells or cell organelles, whereas an environment could be the cells and other tissue within the vicinity of the object. In other embodiments, an object can be a single data, or a set of data, or a pattern of data, surrounded by other data in array form. As it will now occur to those of skill in the art, a data collection area comprising an object and an environment can include any object and environment at any scale ranging from microscopic such as cells to macroscopic such as cities.

Data 56 obtained by at least one data source 105 can be transferred to an apparatus 60 for processing and interpreting in accordance with an embodiment of the invention. In variations, apparatus 60 can be integrated with the data sources 105, or located remotely from the data sources 105. In further variations, data 56 can be further processed either prior to receiving by apparatus 60 or by apparatus 60 prior to performing other operations For example, statistical measures can be taken across the array of data 56 originally recorded. As a further example, in the case of a radar image derived data set, statistical data sets derived from the original radar image pixel values, can be generated for transfer to an apparatus 60 for processing and interpreting. Other variations will now occur to those of skill in the art.

Apparatus 60 can be based on any suitable computing environment, and the type is not particularly limited so long as apparatus 60 is capable of receiving data 56 and is generally operable to interpret data 56 and to identify object 40 and environment 44. In the present embodiment apparatus 60 is a server, but can be a desktop computer client, terminal, personal digital assistant, smartphone, tablet or any other computing device. Apparatus 60 comprises a tower 64, connected to an output device 68 for presenting output to a user and one or more input devices 72 for receiving input from a user. In the present embodiment, output device 68 is a monitor, and input devices 72 include a keyboard 72a and a mouse 72b. Other output devices and input devices will occur to those of skill in the art. Tower 64 is also connected to a storage device 76, such as a hard-disc drive or redundant array of inexpensive discs (“RAID”), which contains reference data for use in interpreting data 56, further details of which will be provided below. Tower 64 typically houses at least one central processing unit (“CPU”) coupled to random access memory via a bus. In the present embodiment, tower 64 also includes a network interface card and connects to a network 80, which can be the intranet, Internet or any other type of network for interconnecting a plurality of computers, as desired. Apparatus 60 can output results generated by apparatus 60 to network 80 and/or apparatus 60 can receive data, in, addition to data 56, to be used to interpret data 56.

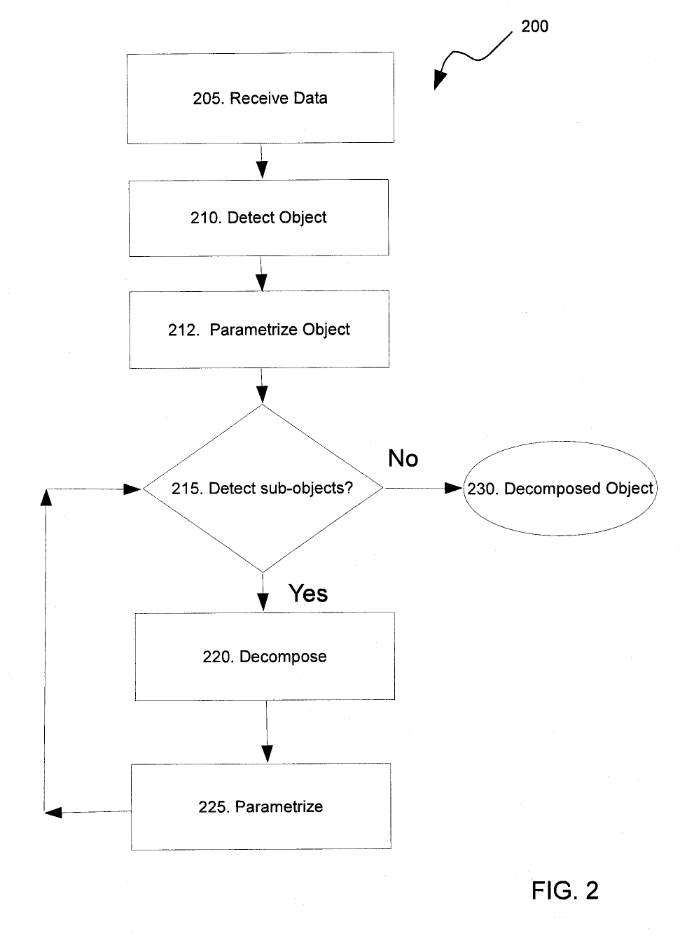

Referring now to FIG. 2 a method of object decomposition is indicated generally at 200. In order to assist in the explanation of the method, it'll be assumed that method 200 is operated using system 100 as shown in FIG.1. The following discussion of method 200 leads to further understanding of system 100. However, it is to be understood that system 100, and method 200 can be varied, and need not work exactly as discussed herein in conjunction with each other.

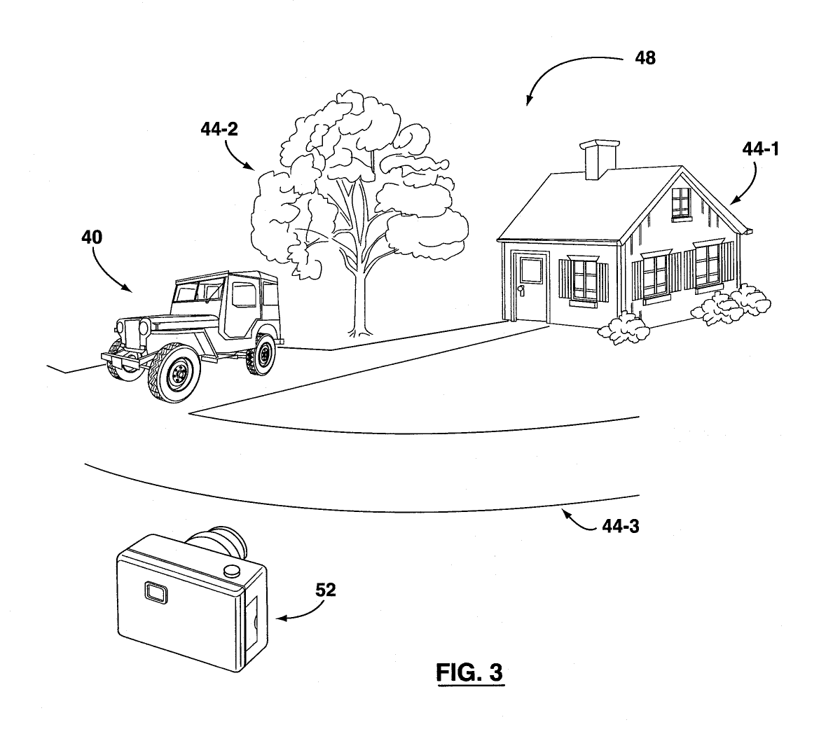

Beginning first at 205, data is received from a data source corresponding to a data collection area. A data collection area can be any area, microscopic or macroscopic, or other form of two or multi-dimensional arrangement of original data, regarding which data can be collected, created and consolidated. Referring to FIG. 3, an example embodiment data collection area, area 48 is shown. It is to be understood that example area 48 is shown merely as an example and for the purposes of explaining various embodiments, and other data collection areas will now occur to a person of skill in the art. Area 48 includes an object 40 and an environment 44 that is comprised of environment objects 44-1, 44-2, and 44-3 within an area 48. In the present example embodiment shown in FIG. 3, the object 40 is a vehicle, whereas the environment object 44-1 is a house, 44-2 is a tree, and 44-3 is a road. Object 40 and the environment 44 have been chosen for illustrative purposes and other objects and environments within an area 48 will occur to those of skill in the art.

Continuing with the example embodiment shown in FIG. 3, a sensing device 52 is shown as example data source 105. The sensing device shown is a digital camera 52. Sensing device 52 have been chosen for illustrative purposes and other sensing devices or non-sensing data sources will now occur to those of skill in the art. For example, sensing devices 52 can include satellite systems, airborne sensors operated at a variety of altitudes, such as on aircraft or unmanned aerial vehicles. Sensing devices 52 can also include mobile ground-based or water-based devices carrying sensors such as railway cars, automobiles, boats, submarines or unmanned vehicles. Handheld sensors, such as digital cameras can also be employed as sensing devices. Sensing devices can also include stationary sensors such as those employed in manufacturing and packaging processes, or in bio-medical applications, such as microscopes, cameras and others. Sensing devices can compose of arrays or other combinations.

Sensing devices can produce a variety of data type outputs such as images derived from electromagnetic spectrum such as optical, infrared, radar and others. Data can also, for example, be derived from magnetic or gravitational sensors. Additionally, data produced or derived can be two, or three dimensional such as three dimensional relief data from LIDAR, or be more dimensional such as n-dimensional data sets in array form where n is an integer value and a multiple of one.

It will now, occur to a person of skill in the art, sensing devices 52 can be operationally located in various locations, remotely or proximally, around and within area 48. For example, for macroscopic scale areas 48, sensing devices 52 can be located on structures operated in space, such as satellites, in air, such as planes and balloons, on land such as cars, buildings or towers, on water such as boats or buoys and in water such as divers or submarines. Sensing devices 52 can also be operationally located on natural structures such as animals birds, trees, and fish. For smaller or microscopic scale areas 48, sensor devices can be operationally located on imaging analysis systems such as microscopes, within rooms such as MRIs on robotic manipulators and other machines such as in manufacturing assemblies. Other locations will now occur to those of skill in the art.

Continuing with the example embodiment, data 56 is received at apparatus 60 from device 52. In the present example embodiment, data 56 includes a photographic image of area 44, but in other variations, as it will occur to those of skill in the art, data 56 can include additional or different types of imaging data or data corresponding to other representations of area 48, alone or in combination. In variations where multiple types or sets of data are present, the different types or sets of data can be combined prior to performing the other portions of method 200, or can be treated separately and combined, as appropriate at various points of method 200.

Next, at step 210, an object is detected by processing the data. In an embodiment, object detection can result in a distinct pattern of elements or an object data signature on the basis of determining a boundary for the data the object. In a variation, the detected object can be extracted from the data 56 enabling, for example, reduced data storage and processing requirements. Referring back to FIG. 3, in the present example embodiment the vehicle is detected as the example object 40, and the resulting object data signature 40′.

Object detection can be performed either automatically or manually. In an embodiment, apparatus 60 is operable to apply to data 56, various data and image processing operations, alone or in combination, such as edge detection, image filtering and segmentation to perform automatic object detection. The specific operations and methods used for automatic object detection can vary, and alternatives will now occur to those of skill in the art.

Manual detection of an object 40 can be performed by an operator using input devices 72 to segment object 40 by identifying, for example, the pixels comprising object 40, or by drawing an outline around object 40, or simply clicking on object 40. The specific operations and methods used for object detection can yes will now occur to those of skill in the art.

In a variation, detection can be assisted based on pre-processing data 56. Pre-processing can generate sets of enhanced or derived data that can replace or accompany data 56. For example, data 56 can be enhanced in preparation for object detection. In other variations, data 56 can be filtered. In yet other variations, imaging measures can be performed such as texture, color, and gradient as well physical measures on basic shapes such as shape size and compactness. Accordingly, object detection can be performed based on the pre-processed data.

Next, at 212 object 40 is parameterized. To accomplish parameterization apparatus 60 is operable to calculate measures for object 40, on the basis of object data signature 40′ for example. For example, apparatus 60 can derive certain physical measures such as size and compactness for object 40 based on object data signature 40′. In one variation, an object 40 can be characterized, where appropriate as one of a basic geometric shape such as a circle, rectangle, trapezoid, multi-sided, irregular, sphere, doughnut, and others that will now occur to a person of skill in the art. Once an object 40 is characterized as a basic shape, certain physical measures can be derived such as radius, length of sides, ratio of side lengths, area, volume size, compactness and others that will now occur to a person of skill in the art. In other variations, measures can be calculated based on sensory data characteristics that can be derived for an object 40 from the modality of data 56. For example, for photographic images, the sub-objects can be translated into, through image processing, composition of color, gray value gradients, tone measures, texture measures and others that will now be apparent to those of skill in the art.

Continuing with method 200, at 215, sub-objects of an object are detected. In an embodiment, an analysis of the previously detected object data signature can be performed to determine whether the object can be further decomposed into a second level of sub-objects, i.e. whether the object is a higher-level object. Accordingly, an object is either identified as a primitive object, which does not have any detectable sub-objects, or a higher-level object which does have detectable sub-objects. The identification of an object as a primitive object or as a higher-level object can be accomplished automatically or manually using various data and image processing algorithms, alone or in combination, such as edge detection, image filtering and segmentation to perform sub-object detection. The specific operations and methods used for object detection can vary, and alternatives will now occur to those of skill in the art.

In a variation, detection of sub-objects can be assisted based on pre-processing the detected object or object data signature. Pre-processing can generate sets of enhanced or derived data that can replace or accompany the object and its data signature. For example, object data signature can be enhanced in preparation for object detection. In other variations, object data signature can be filtered. In yet other variations, when the object is part of a digital image, imaging measures can be performed such as texture, color, gradient, histogram, or other measures, such as statistical measures, as well physical measures on basic shapes such as shape size and compactness. In variations, such pre-processing can be applied to any data in, for example, an array form representing the object, and the results of such pre-processing can be stored and utilized as additional derived data sets accompanying the original data containing the original object during object classification and recognition Accordingly sub-object detection can be performed based on the pre-processed data.

Continuing with the example embodiment, to accomplish sub-object detection apparatus 60 is operable to apply to an object data signature various data and image processing algorithms.

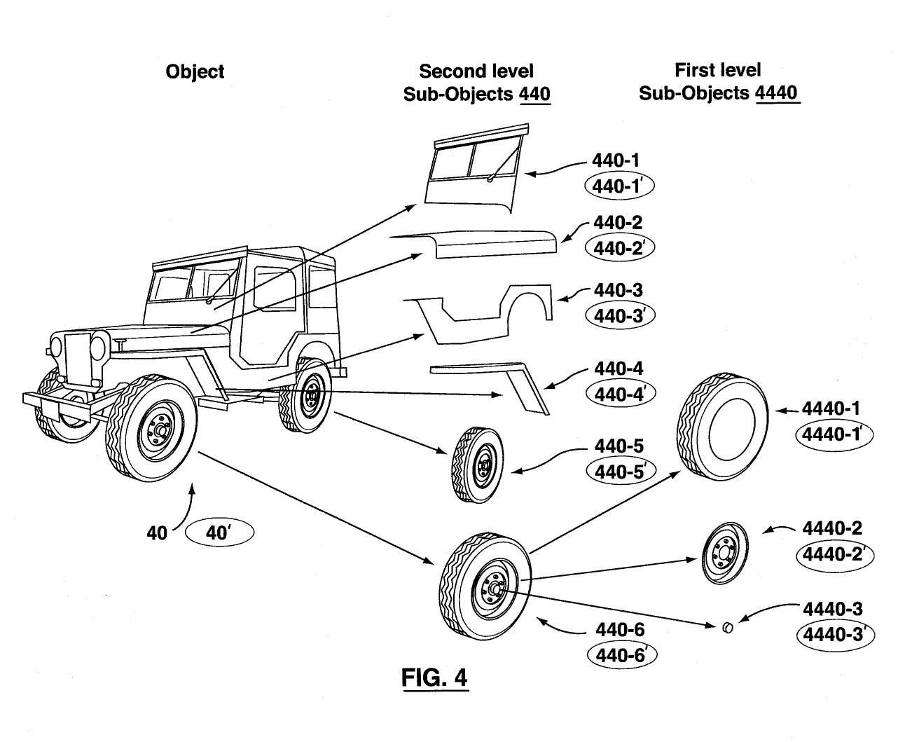

Referring now to FIG. 4, an example detection of sub-objects based on the example object 40 is shown in a graphical manner for the purposes of explaining the process. Although graphical representation of object 40 and its sub-objects are shown for ease of illustration, it is to be understood that the actual data used in the performance of method 200 using the example embodiment of FIG. 3 involves derived object data signature 40′ and corresponding derived sub-object data signatures indicated in FIG. 4. Continuing with the present example embodiment, and as shown in FIG. 4, sub-objects 440 are second-level elements which comprise object 40. For example, example object 40, which is a vehicle, is decomposed, based on the corresponding object data signature 40′, into sub-objects windshield 440-1 and the corresponding sub-object data signature 440-1′, hood 440-2 and the corresponding sub-object data signature 440-2′, side panel 440-3 and corresponding the sub-object data signature 440-3′, splash guard 440-4 and the corresponding sub-object data signature 440-4′, rear wheel 440-5 and the corresponding sub-object data signature 440-5′ and front wheel 440-6 and the corresponding sub-object data signature 440-6′. Collectively, second level sub-objects 440-1, 440-2, 440-3, 440-4, 440-5 and 440-6 are referred to as second level sub-objects 440, and generically as second level sub-object 440. Collectively, second level sub-object data signatures 440-1′, 440-2′, 440-3′ 440-4′, 440-5″ and 440-6′ are referred to as second level sub-object data signatures 440′, and generically as second level sub-object data signature 440′. This nomenclature is used elsewhere herein. Although in the present embodiment second level sub-objects 440-1 through 440-6 are detected, it will now occur to a person of skill in the art that in variations additional or different sub-objects can be detected based on the type of algorithms and modalities used. Since sub-objects are detected, method 200 progresses next to step 220.

At 220, apparatus 60 decomposes object 40 into the detected sub-objects and their connectivities. In the present embodiment, this represents the second level of decomposition and results with storage of second level sub-object data signatures 440′ in a data structure capable of storing multi-dimensional data structures, either separately, or in combination with data 56. The second level decomposition can be based on object data signature 40′ and/or second level sub-object data signatures 440′.

In general, an object 40 can be decomposed into all of the sub-objects detectable in data 56, or can be decomposed into a subset of the detectable sub-objects to increase the efficiency of the algorithm. The selection of the subset of sub-objects can be based on, at least in part, the type of object being identified, the modality of data 56 or the type of image sensing device 52 or data source 105 used in obtaining data 56, which can thus be of imaging or non-imaging type including any type of data derived from data 56, so as to increase the accuracy of object identification. For example, in some variations, sub-objects that are frequently found in most objects can be avoided to increase the efficiency of the algorithm without reducing accuracy since their contribution to object identification can be relatively small or.

Sub-object connectivities define how each sub-object is connected or related to other sub-objects in its level, including itself where appropriate. For example, connectivities can define physical connections where second level sub-objects 440 are directly connected to each other as with hood 440-2, and side panel 440-3. In other variations, connectivities can define relative physical placement in two or three dimensions such as physical distance between sub-objects, or relative distance as in the case of sub-object side panel 440-3 and sub-object rear wheel 440-5 which are adjacent to each other, or as in, the case of hood 440-2, and rear wheel 440-5 which are separated by one other sub-object. Connectivities can also define how sub-objects are functionally related including chain of logic interdependencies. For example, in the example shown in FIG. 4, sub-object rear wheel 440-5 has the relationship “supports on ground” for side panel 440-3. In other variations, temporal relationships can also be defined if the sub-objects alter appearance over time for example. At this point it will occur to one of skill in the art that connectivities can be defined using various other forms of functional, temporal or physical relationships between one or more sub-objects. In general, not all possible connectivities are utilized or calculated when decomposing an object 40 into sub-objects 440. The selection of the subset of connectivities can be based on, at least in part, the type of object being identified, the modality of data 56 or the type of image sensing device 52 used to acquire the data, or the type of non-imaging device otherwise employed as a source of data 56, so as to increase the accuracy of object identification. For example, in some variations, connectivities that are frequently found in most objects can be avoided to increase the efficiency of the algorithm without reducing accuracy since the contribution of such connectivities to object identification can be relatively small.

Referring now to Table I, and continuing with example embodiment of FIG. 4, connectivities 450 is shown in the form of relative spatial relationship between second level sub-objects 440.

TABLE I
Connectivities 450

| | | | | | Rear | Front |
|---|---|---|---|---|---|---|
| | Windshield | | Panel | Guard | Wheel | Wheel |
| Sub-Objects | 440-1 | Hood 440-2 | 440-3 | 440-4 | 440-5 | 440-6 |
| Windshield | Not Defined | Adjacent | Separated | Separated | Separated | Separated |
| 440-1 | | | by Hood | by Hood | by Hood | by Hood |
| | | | 440-2 | 440-2 | 440-2, | 440-2, |
| | | | | | panel 440-3, | guard 440-4 |
| Hood 440-2 | | Not Defined | Adjacent | Adjacent | Adjacent | Separated |
| | | | | | | by guard |
| | | | | | | 440-4 |
| Panel 440-3 | | | Not | Adjacent | Adjacent | Separated |
| | | | Defined | | | by guard |
| | | | | | | 440-4 |
| Guard 440-4 | | | | Not | Separated | Adjacent |
| | | | | Defined | by Panel | |
| | | | | | 440-3 | |
| Rear Wheel | | | | | Not | Separated |
| 440-5 | | | | | Defined | by panel |
| | | | | | | 440-3, |
| | | | | | | guard 440-4 |
| Front Wheel | | | | | | Not |
| 440-6 | | | | | | Defined |

Continuing with Table 1, row 2 shows the relative spatial relationship between sub-object Windshield 440-1 and other sub-objects identified in FIG. 4, which can be employed as connectivities between subobjects, in this case as spatial connectivities. Accordingly, and referring to row 2 of Table I, windshield 440-1 is adjacent to hood 440-2; is separated by one sub-object, hood 440-2, from panel 440-3; is separated by 1 sub-object, hood 440-2, from splash guard 440-4; is separated by two sub-objects, hood 440-2, side panel 440-3, from rear wheel 440-5; and is separated by two sub-objects, hood 440-2 and splash guard 440-4, from front wheel 440-6. Continuing with row 3 of Table I, hood 440-2 is adjacent to side panel 440-3; is adjacent to splash guard 440-4; is adjacent to rear wheel 440-5; and is separated by one sub-object, splash guard 440-4, from chassis 440-6. Continuing with row 4 of Table I, side panel 440-3 is adjacent to splash guard 440-4; is adjacent to rear wheel 440-5; and is separated by splash guard 440-4, from front wheel 440-6. Continuing with row 5 of Table I, splash guard 440-4 is separated by one sub-object, side panel 440-3 from rear wheel 440-5; and is adjacent to front wheel 440-6. Continuing with row 6 of Table I, rear wheel 440-5 is separated by side panel 440-3 and splash guard 440-4, from front wheel 440-6. Although in the present embodiment connectivities are comprised of relative spatial relationships other connectivities will now occur to those of skill in the art and can be used in variations. In a variation, objective measures can be generated based on connectivities 450, and such objective measures based on connectivities 450 can be stored as entries in a multi-dimensional data base for further processing and use in object classification and recognition.

At 225, apparatus 60 is operable to parametrize at least some of the second level sub-objects 440 and their connectivities 450. To accomplish parameterization apparatus 60 is operable, for example, to calculate measures on the basis of sub-object data signatures 440′ and connectivities 450. For example, apparatus 60 can derive certain physical measures such as size and compactness for sub-objects 440 based on second level sub-object data signatures 440′. In one variation, a sub-object 440 can be characterized, where appropriate, as one of a basic geometric shape such as a circle, rectangle, trapezoid, multi-sided irregular, sphere, doughnut, and others that will now occur to a person of skill in the art. Once a sub-object 440 is characterized as a basic shape, certain physical measures can be derived such as radius length of sides, ratio of side lengths, area, volume size, compactness and others that will now occur to a person of skill in the art. In other variations, measures can be calculated based on sensory data characteristics that can be derived for each sub-object 440 from the modality of data 56. For example, for photographic images, the sub-objects can be translated into, through image processing, composition of color, gray value gradients, tone measures, texture measures and others that will now be apparent to those of skill in the art.

Referring to FIG. 4 and continuing with the present example embodiment, at least a radius and a circumference is calculated and stored for the sub-object front wheel 440-56 and at least a length is calculated and stored for the sub-object side panel 440-3, and a translucence measure for sub-object windshield 440-1. It will now occur to a person of skill in the art that various representations, both quantitative and qualitative and data structures such as multi-dimensional matrices, or databases or a combination thereof can be used to represent and store parameterized sub-objects 440 and corresponding data signatures 440′ and stored either at storage device 76 or other storage devices in communication with apparatus 60, for example through network 80.

Referring now to Table II, a parameterized form of connectivities 450 is indicated in the form of a matrix that shows the relative logical distance between sub-objects 440, as calculated in the present embodiment.

TABLE II
Parameterized connectivities 450

| | Wind- | | | | Rear | Front |
|---|---|---|---|---|---|---|
| | shield | Hood | Panel | Guard | Wheel | Wheel |
| Sub-Objects | 440-1 | 440-2 | 440-3 | 440-4 | 440-5 | 440-6 |
| Windshield | Not | 0 | 1 | 1 | 2 | 2 |
| 440-1 | Defined | | | | | |
| Hood 440-2 | | Not | 0 | 0 | 1 | 1 |
| | | Defined | | | | |
| Panel 440-3 | | | Not | 0 | 0 | 1 |
| | | | Defined | | | |
| Guard 440-4 | | | | Not | 1 | 0 |
| | | | | Defined | | |
| Rear Wheel | | | | | Not | 2 |
| 440-5 | | | | | Defined | |
| Front Wheel | | | | | | Not |
| 440-6 | | | | | | Defined |

Although, in the present example embodiment a table was used to represent parameterized connectivities 450, if will now occur to a person of skill in the art that various other representations, both quantitative and qualitative and data structures such as multi-dimensional matrices, or databases or a combination thereof can also be used to represent and store parameterized connectivities 450 and other parameters. Furthermore, parameterized sub-objects 440, parameterized connectivities 450, sub-object data signatures 440′, and other relevant data can be stored separately, in combination, and in combination with or linked to data 56 and data related to object 40 including object data signature 40′, and parameters derived from it, resulting in a highly multi-dimensional data structure or database corresponding to object 40. Moreover it will also occur to a person of skill in the art that although in the present embodiment the type of connectivities shown is relative spatial distance, in other variations other types of connectivities can be calculated, represented and stored, including those based on spatial, temporal and functional relationships of sub-objects.

Referring back to FIG. 2, method 200 advances to 215. At 215, apparatus 60 now analyzes each sub-object 440 to determine whether any of the sub-objects identified at the second level of decomposition of object 40 can be further decomposed into other sub-objects, i.e. whether object 40 can be further decomposed into a first, or lowest, level decomposition by decomposing at least one of its second level sub-objects 440 into further sub-objects. Accordingly every sub-object, similar to an object, is either identified as a primitive sub-object, which does not have any detectable sub-objects or a higher-level sub-object that does have detectable sub-objects. The identification of sub-objects as primitive or as higher-level can be accomplished using various data and image processing algorithms to detect further sub-objects in each sub-object as described above for the detection of sub-objects within an object. The determination of what a primitive object or sub-object is can be partly based on the type of object being identified, the modality of data 56 or the type of image sensing device 52. For example, if the data 56 is obtained from a plane, the resolution and angle may only be appropriate for distinguishing headlights as opposed to light bulbs contained within headlights, and thus, headlights can constitute as a primitive objects or sub-objects for the example. Although in the present example, the first level decomposition is the lowest level of decomposition, in variations, there can be more or fewer levels of decomposition. In a further variation, the previously decomposed objects stored at apparatus 60 can be used to determine as to what constitutes a primitive object or sub-object. Namely, the objects or sub-objects can be decomposed to the level that matches the reference object decomposition. In a further variation, a sub-object or object can be compared to stored primitive sub-objects or objects to determine the classification as primitive. In an additional variation, a primitive object or sub-object can occur in multiple types of higher-level objects or sub-objects. For example a small circle can occur as a nut in a wheel, or light bulbs in head lights.

Referring back to FIG. 4, and continuing with the present example embodiment second level sub-object front wheel 440-6 is determined to have sub-objects 4440 which form the first, or lowest, level of decomposition for object 40. An example detection of first, or lowest, level sub-objects 4440 based on the example second level sub-object front wheel 440-6 is shown in a graphical manner for ease of illustration. Although graphical representation of object 40 and its sub-objects are shown for ease of illustration, it is to be understood that the actual data used in the performance of method 200 using the example embodiment of FIG. 3 typically involves derived object data such as data signature 40′ and corresponding derived sub-object data signatures indicated in FIG. 4. Continuing with the example embodiment of FIG. 4, first, or lowest, level sub-objects 4440 are elements that compose the example second level sub-object 440-6. Namely, sub-object 440-6, which is a front wheel, is decomposed into first, or lowest, level sub objects fire 4440-1 and the corresponding first, or lowest, level sub-object data signature 4440-1′, rim 4440-2 and the corresponding first, or lowest, level sub-object data signature 4440-2′ and nut 4440-3 and the corresponding second level sub-object data signature 4440-3′. Collectively, first, or lowest, level sub-objects 4440-1, 4440-2 and 4440-3 are referred to as first, or lowest, level sub-objects 4440, and generically as first, or lowest, level sub-object 4440. Collectively, first, or lowest, level sub-object data signatures 4440-1′, 4440-2′and 4440-3′ are referred to as first or lowest level sub-object data signatures 4440′, and generically as first, or lowest, level sub-object data signature 4440′. This nomenclature is used elsewhere herein. Moreover, although in the present embodiment sub-objects 4440-1 through 4440-2 are detected, it will now occur to a person of skill in the art that in variations, additional or different sub-objects can be detected based on the type of algorithms, and modalities used. Since at least one sub-object is determined to be higher level object, method 200 progresses next to 220.

At 220 apparatus 60 decomposes sub-object 440-6 into the detected sub-objects and connectivities. Continuing with the example embodiment of FIG. 4, and referring now to Table Ill, example connectivities 4450 is shown in the form of relative spatial relationship between sub-objects 4440, determined based on first or lowest level sub-object signature data 4440′.

TABLE III
Connectivities 4450

| Sub-Objects | Tire 4440-1 | Rim 4440-2 | Nut 4440-3 |
|---|---|---|---|
| Tire 4440-1 | Not Defined | Adjacent | Separated by |
| | | | Rim 4440-2 |
| Rim 4440-2 | | Not Defined | Adjacent |
| Nut 4440-3 | | | Not Defined |

At 225, apparatus 60 is operable to parameterize at least some of the first, or lowest, level sub-objects 4440 and connectivities 4450. In the present example embodiment, parameterization is accomplished by apparatus 60 by calculating measures on the basis of sub-objects 4440 as well as connectivities 4450. Referring to FIG. 4 and continuing with the present embodiment, at least a radius and a circumference is calculated for all of the sub-objects 4440. It will now occur to a person of skill in the art that various representations, both quantitative and qualitative and data structures such as multi-dimensional matrices, or databases or a combination thereof can be used to represent and store parameterized sub-objects 4440 and corresponding sub-object data signatures 4440′ and stored either at storage device 76 or other storage devices in communication with apparatus 60, for example, through network 80. In some variations, these data structures used for representing and storing sub-object 4440 and corresponding data signatures 4440′ can be different from the data structures used to store parameterized sub-objects 440. They can, for example, be extensions of the da structures used to store parameterized sub-objects 440, or they can be linked to the data structures used to store parameterized sub-objects 440.

Referring now to Table IV, a parameterized form of connectivities 4450 is indicated in the form of a matrix that shows the relative logical distance between sub-objects 4440, as calculated in the present example embodiment.

TABLE IV
Connectivities 4450

| Sub-Objects | Tire 4440-1 | Rim 4440-2 | Nut 4440-3 |
|---|---|---|---|
| Tire 4440-1 | Not Defined | 0 | 1 |
| Rim 4440-2 | | Not Defined | 0 |
| Nut 4440-3 | | | Not Defined |

Referring back to FIG. 4, and continuing with the method at 215, apparatus 60 now analyzes each sub-objects 4440 to determine whether any of the identified sub-objects 4440 can be further decomposed into other sub-objects, i.e. whether any of the sub-objects 4440 are higher-level sub-objects. In the present example embodiment, it will be assumed that the sub objects 4440 are all primitive sub-objects so the method 200 advances to 230.

Referring now to FIG. 2, at 230 the decomposed object is stored using a data structure or structures that represent and characterizes the object including its identified sub-objects, connectitivities and parameters. The stored data structure or structures can include representation of each object, all or some of its sub-objects, connectivities and parameters derived from all or some of its sub-objects and connectivities of sub-objects. It will now occur to a person of skill in the art that various representations, both quantitative and qualitative and data structures such as multi-dimensional matrices, or databases or a combination thereof can also be used to represent and store the decomposed object 40 and can be stored either at storage device 76 or other storage devices in communication with apparatus 60, for example, through network 80. For example, in one variation, the data structure used can be hierarchical to correspond with the hierarchical nature of the levels of sub-objects.

In the present embodiment, method 200 is performed by apparatus 60 until all detected sub-objects have been decomposed into primitive sub-objects; namely until all detected higher-level objects have been decomposed into primitive objects. In a variation, the decomposition can be repeated until a predetermined number “n” of iterations of the algorithm has been reached. Where n is set to one, an object is decomposed once into its immediate sub-objects, namely the second level of sub-objects. Where n is set to an integer greater than one an object and its sub-objects will iterate through method 200 n times, as long as there are higher-level sub-objects available, generating n-level decomposition of the object. In a further variation, the object 40 can be decomposed only to a level of decomposition that matches the decomposition level of a stored decomposed object that is used as a reference for the decomposition and processing.

Referring now to Fig, 5, a method for object recognition or identification is shown generally at 500. In order to assist in the explanation of the method, it'll be assumed that method 500 is operated using system 100 as shown in FIG. 1. The following discussion of method 500 leads to further understanding of system 100. However, it is to be understood that system 100, and method 500 can be varied, and need not work exactly as discussed herein in conjunction with each other.

At 505 a decomposed object is received by apparatus 60. The received object can be represented by one or more data structures and, as described above, can include representation of each object, all or some of its sub-objects, connectivities and parameters derived from all or some of its sub-objects and connectivities of sub-objects.

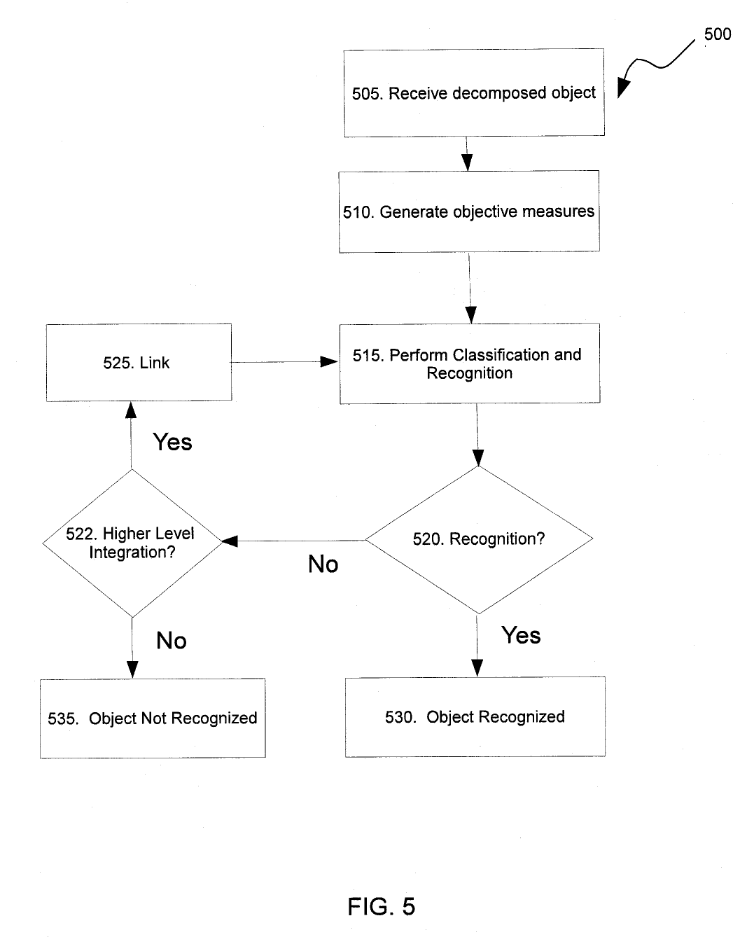

Continuing with FIG. 5 and referring to 510, apparatus 60 generates objective measures based on the decomposed object. Objective measures can be generated on the basis of all or a group of sub-objects, and their corresponding qualitative and quantitative parameters and connectivities. In the example embodiment of FIG. 4, sub-objects that form the lowest decomposition level, namely the decomposition level containing the most granular sub-objects of first or lowest, level sub-objects 4440 and their corresponding parameters and connectivities are used. In variations, sub-objects from other levels or from a mixture of levels can also be used.

Objective measures include data that represents occurrence or co-occurrence of sub-objects, connectivities and related measures either individually or as combinations and can be maintained as entries within a data storage matrix, such as multi-dimensional database. Objective measures can further include results of additional calculations and abstractions performed on the parametric measures, objects, sub-object and corresponding data signatures and connectivities related to those sub-objects. In a variation, the sub-objects and connectivities recorded during the object decomposition can be entered info the “primary” custom designed multi-dimensional database as patterns of database entries and connectivity networks. In a further variation, classification measure can be the decomposed object data structure received for the sub-objects used.

A set of objective measures can be represented as a set within a secondary multi-dimensional data structure such as a multi-dimensional matrix, representing a multi-dimensional feature space. It will now occur to those of skill in the art that various other operations and calculations, such as inference analysis, can be performed on decomposed object data structure to generate additional data for use as part of a classification measure, and that the resulting set of objective measures can be stored, either at storage 76 or other storage operably connected to apparatus 60, for example, through network 80, using various representations and data structures including multi-dimensional matrices or data structures.

Continuing with the example object 40 of the example embodiment, a set of objective measures, starting at the lowest level of decomposition, which in the present embodiment is second decomposition level, includes the co-occurrence of at least two of the three sub-object 4440, the measures generated for each sub-objects 4440, radius and circumference, and the parameterized connectivities 4450 of Table IV.

Referring back to FIG. 5, at 515 classification and recognition is performed. To accomplish classification and recognition, apparatus 60 retrieves one or more sets of objective measures and enters the objective measures into multi-dimensional feature space In a variation, objective measures retrieved can be based on sub-objects and or corresponding sub-object signature data, parameters generated on the basis of the signature data connectivities and parameterized connectivities, alone or in combination can be used as entries into a primary multi-dimensional database to be analyzed and processed into objective measures. In another variation, not all sub-object, connectivities and paramaters, and corresponding data such as objective measures taken from the occurrence and co-occurrence of lesser than all sub-objects, connectivities and paramaters, is used in classification and recognition and partial data sets can be relied on to perform this operation. For example, objective measures can be classified in terms of priority and retrieved accordingly. Alternatively, they can be chosen randomly. In a variation, rule based classification based on pure association of objective measures is performed within the multi-dimensional feature space. Accordingly, recognition can be made by applying rule based processing as immediate associative processing of occurrence and co-occurrence of entries, thus depending on the level of object recognition required, short cutting the overall process. In another variation semantic recognition can be used. In other variations the co-occurrence of elements as well as the connectivities, can be described as abstract patterns such that, patterns of co-occurrence of elements and across connectivities become apparent. The classification and recognition operation, in these variations, can comprise analyzing patterns of entries across the different dimensions of the primary database, and determining sets of results characterizing these patterns, for example as vectors characterizing those patterns, which, in these variations, are then used for classification and recognition of the object through processing within the secondary database, e.g., a multi-dimensional feature space. In yet other variations, combination of one or more different recognition operations can be used.

In other variations, other classifications, as they will now occur to a person of skill in the art can be performed. For example, objective measures related to different objects that are typically part of a database stored either at storage 76 or other storage operably connected to apparatus 60 through, for example, network 80 can be retrieved. Once the reference objective measures are retrieved, they can be compared against the calculated objective measures for the object currently being identified.

In an embodiment, the comparison can be a simple comparison of each objective measure for occurrence or co-occurrence. In a variation where all classification measures are quantitative, a vector operation of multiple classification measures can constitute the comparison. In a further variation, when stored as a pattern, the co-occurrence of elements, as well as the connectivities, can be described as abstract patterns such that, patterns of co-occurrence of elements and across connectivities become apparent. The comparison in these variations can comprise analyzing patterns across the different dimensions, and determines sets of comparison results characterizing these patterns, or example as vectors characterizing those patterns.

It will now occur to those of skill in the art that the comparison can include many different operations performed on various multi-dimensional sets including quantitative or qualitative elements.

The result of the recognition can be an inference indicative of the degree of confidence on the basis of classification and recognition. In the present embodiment, the results of the comparison are indicated as a 0 or a 1, 1 indicating a highest confidence, and 0 indicating no confidence. In variations, probabilities can be generated to indicate the degree of confidence. In yet other variations, vectors of results can be generated each element of which indicates various dimensions of confidence, such as confidence in sub-object presence, connectivities, pattern matching results and/or other measures. It will now occur to those of skill in the art that the comparison results can include many different results including quantitative or qualitative results.

In further variations, classification and recognition can be applied to each sub-object and the results of such operations, as well as any recognition results stored. Accordingly, during reiteration of method 500, the recognized sub-objects, their objective measures, their recognition results and other corresponding data can be used for generation of additional objective measures at 510, and subsequently in the classification and recognition of the entire object through the rest of method 500,

Continuing with method 500, at 520, a determination is performed as to whether an object can be classified and recognized. The identification is typically based on the confidence results. In a further variation recognition 520 can be delayed until a number of or all decomposition levels as well as the object are analyzed. In the present embodiment, it'll be assumed, for illustrative purposes, that the comparison result is a 0 and that accordingly, method 500 advances to step 522.

At 522 a determination is made as to whether a higher decomposition is available where sub-objects at a higher level of integration are present. The determination is yes if current-level sub-objects form higher-level sub-objects, and accordingly, the current level sub-objects can be linked to form higher level or more highly integrated sub-objects. If the determination is no, accordingly, the highest level of decomposition, namely the greatest level of integration (in this example embodiment the object itself) has been reached and thus the object is not recognized as determined at 535. Since, in accordance with the present example, sub-objects of higher level integration exist, method 500 advances to 525.

At 525, parametric measures associated with sub-objects 4440 are linked on the basis of connectivities to obtain linked objective measures. In a variation the linking can include either all sub-objects 4440 and correlated data or can be reduced to re-combining the intermediate processing results from just several sub-objects 4440 to generate additional linked objective measures.

Advancing to 510, apparatus 60 generates objective measures based on the sub-objects of the next decomposition level, namely sub-objects 440. In variations, sub-objects from other levels or from a mixture of levels can also be used. In addition additional classification measures can be generated on the basis of linked parametric measures. In a further variation, classification measures can be linked on the basis of connectivities of the sub-objects 4440 to generate linked classification measures.

Next, at 515, classification and recognition is performed for sub-objects 440 Assuming now that the results of classification and recognition 520 yields high confidence recognition, above that of a predetermined threshold, method 500 terminates by identifying the example object as a vehicle at 530.

In the example embodiment, identification is assumed to have occurred when all decomposition levels were analyzed in an iterative manner, one level at a time. In a variation, all sub-objects can be analyzed at once. In other variations, recognition can occur earlier, or only at the primitive level. In further variations, even if recognition occurs at a lower level of decomposition (for example at the level of nuts and bolts in the example) method 500 can continue to iterate through sub-objects with higher level of integration (for example wheels in the example) to further increase confidence in classification and recognition results. This is in accordance with the fact that in some variations, each iteration of method 500 through sub-objects with higher level of integration can serve to strengthen confidence.

Although methods 200 and 500 were presented in a specific order, they do not have to be performed in exactly the manner presented. In variations, elements from each method can be mixed and also elements within each can be performed in order different from shown. For example, in one variation, an object or individual sub-objects can be classified and recognized.

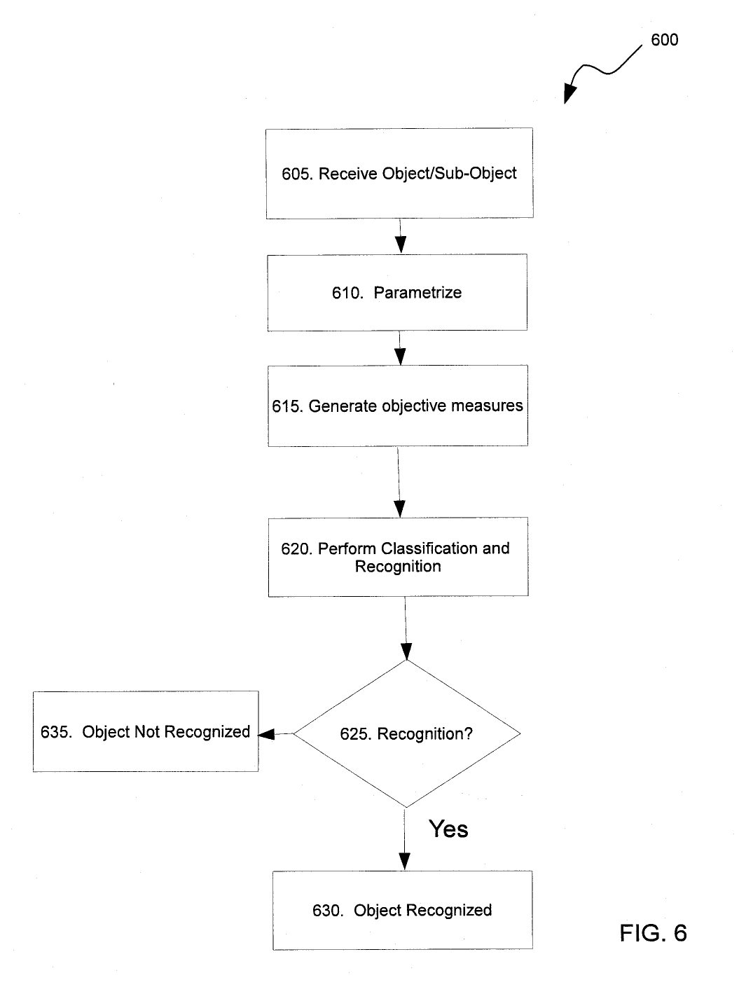

Referring now to FIG. 6, a method for object or sub-object recognition or identification is shown generally at 600 in accordance with a variation of methods 200 and 500. In order to assist in the explanation of the method, it'll be assumed that method 600 is operated using system 100 as shown in FIG. 1. The following discussion of method 600 leads to further understanding of system 100. However, it is to be understood that system 100, and method 600 can be varied, and need not work exactly as discussed herein in conjunction with each other.

Referring to FIG. 6, at 605 a previously detected object and its corresponding data, such as its object data signature is received. And object or sub-object can be detected in a similar manner as discussed above for method 200. Next, 610 of method 600 corresponds to 212 of method 200 and is performed in substantially the same manner. Accordingly, once 605 and 610 are performed, a single detected object or sub-object is received and parameterized. Furthermore, 615, 620 and 625 of method 600 correspond to 510, 515 and 520 of method 500 and are performed in substantially the same manner. However, at 615 and 625 just the received object or sub-object and its associated parameters as determined at 605 are used to generate objective measures and perform classification and recognition. Accordingly, once an object or sub-object is parameterized at 605, objective measures are generated on the basis of the parameters and classification and recognition is performed in a similar manner as described above. Next, if it is determined at 625 that a predetermined confidence level of recognition is not reached, then it is determined that the object cannot be identified at 635. On the other hand, if at 625 it is determined that a predetermined confidence level of recognition is reached, the object is recognized or identified at 630.

In another variation of methods 200 and 500, objective measures can be generated as an object is decomposed, and recognition determined at each decomposition level before decomposing the object any further.

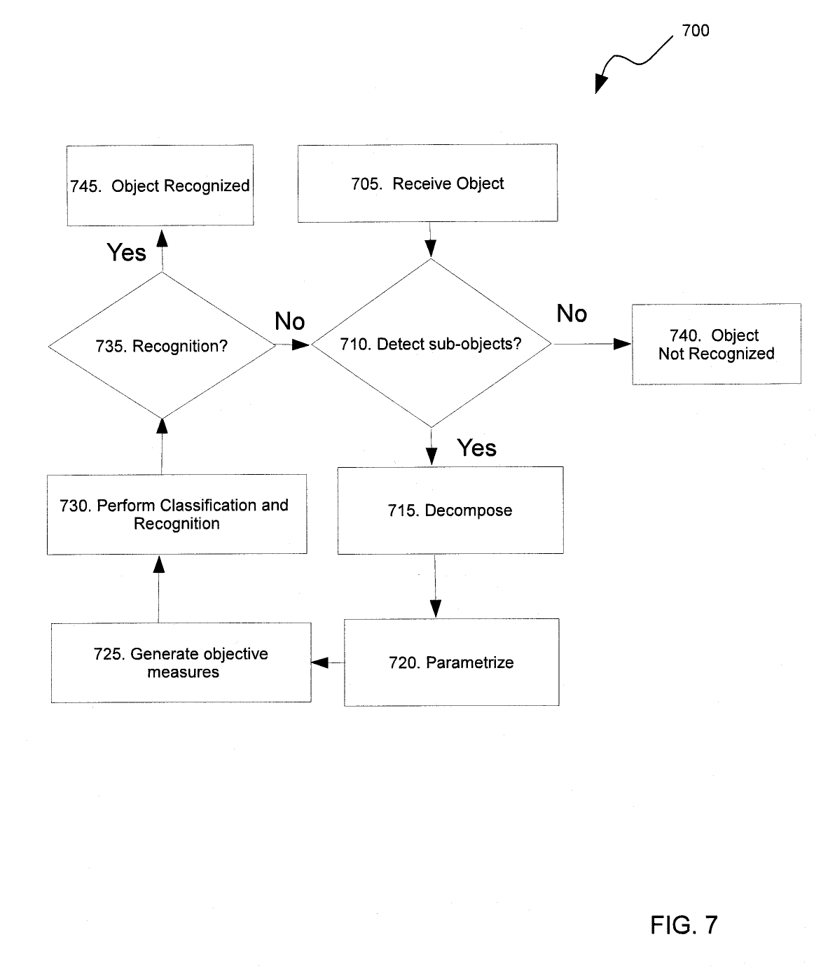

Referring now to FIG. 7, a method for object decomposition and recognition or identification is shown generally at 700 in accordance with a variation of methods 200 and 500. In order to assist in the explanation of the method, it'll be assumed that method 700 is operated using system 100 as shown in FIG. 1. The following discussion of method 700 leads to further understanding of system 100. However, it is to be understood that system 100, and method 700 can be varied, and need not work exactly as discussed herein in conjunction with each other, and that such variations are within scope.

Referring to FIG. 7, at 705 a previously detected object and its corresponding data, such as its object data signature is received. And object can be detected in a similar manner as discussed above for method 200. In a variation, the object may have been processed through method 600 first to determine whether it can be recognized by itself. 710, 715 and 720 of method 700 correspond to 215, 220 and 225 of method 200 and are performed in substantially the same manner. Accordingly, the received object is decomposed into its second level of sub-objects and parameterized. Next, at 725 through 735, objective measures are generated and recognition is performed in a similar manner as described above in method 500. 725 through 735 of method 700 correspond to 510 through 520 of method 500 and are performed in substantially the same manner. However, just the last decomposed set of sub-objects and their associated connectivities and parameters as determined at the last performance of 715 and 720 are used to generate objective measures and perform classification and recognition. Moreover, further decomposition at 710 is carried out when a predetermined confidence level of recognition is not reached. If, after it is determined at 735 that a predetermined confidence level of recognition is not reached, and it is further determined at 710 that the object has been decomposed to its primitive elements, then at 740 it is determined that the object cannot be identified. On the other hand, if at 735 it is determined that a predetermined confidence level of recognition is reached, the object is recognized or identified at 745. In variations of method 700, linked objective measures can also be used in generation of objective measures. In yet other variations of methods 200, 500, 600 and 700, the decomposed object is not stored, but rather the objective measures are stored after each decomposition iteration. Moreover, the decomposition can be terminated if, at any level, a predetermined degree of classification and recognition is achieved. It will now occur to a person of skill in the art that methods 200, 500, 600 and 700 can be performed in various orders, and also intermixed with each other.

In further variations of method 200, 500, 600 and 700, not all sub-objects detected are used in the decomposition or recognition processes. Accordingly, even when the data 56 does not allow for detection of all sub-objects, identification can still be accomplished. In further variations, detection of objects and sub-objects can be performed at different resolutions allowing the methodology to be applied to objects with varying degree of complexity. In yet other variations, limiting storage of object and sub-object data to data signatures and parameterized sets of data can reduce the amount of storage needed by abstracting away the objects and sub-objects from image data. In additional variations, each identified sub-object can be iterated through methods 200 and 500, one by one, resulting in recognized sub-objects that can then be used in the recognition process of the object.

In further variations, data 56 can also be analyzed to detect the environment objects 44 surrounding object 40. Accordingly each environment object can be identified using methods 200, 500, 600 and or 700 and as described above, or variations thereof, and the results of this identification can be used to further improve the identification of object 40. In an embodiment, environment parameters can be generated for environment objects and can be used in generating additional objective measures during object identification. For example, location and positioning on an object 40 in relation to environment objects 44 can further inform identification of object 40. In a further variation, environment objects and sub-objects can be linked to object 40 or sub-objects of object 40 and their links that can be used in determining objective measures.

Once an object 40 and its environment objects 44 is classified, recognized or otherwise identified they can be indicated on a graphical output device as part of a representation of area 48. The indication can take the form of graphical indicators, text indicators or a combination. The representation of area 48 can take the form of a digital map, a photograph, an illustration, or other graphical representation of area 48 that will now occur to those of skill in the art. For example, objects can be outlined or otherwise indicated on a digital map a digital photograph of area 48 using certain colors for different types of objects 40 or environmental object 44. In this example, one color can be used for indicating objects 40 and environmental object 44 identified as man-made structures, another for objects 40 and environmental objects 44 identified as natural structures, and other color object combinations that will now occur to a person of skill in the art. Further color representations or hues can be used to differentiate between different types of man-made structures or natural structures. In this case, dark blues can be used to indicate rivers, and light blue, seas, for example. Textual description of the identified objects 40 and environment objects 44 can also be included as part of the graphical representation of area 48. The textual descriptions such as vehicle, river and others can appear superimposed on top of the identified objects 40 and environmental object 44, near the identified objects 40 or environmental objects 44 or can appear or disappear after a specific trigger action such as a mouse-over, or a specific key or key sequence activation. It will now be apparent to those of skill in the art that different types of coloring, shading and other graphical or textual schemes can be used to represent identified objects 40 and environment objects 44 within a representation of area 48.

The many features and advantages of the invention are apparent from the detailed specification and, thus, it is intended by the appended claims to cover all such features and advantages of the invention that fall within the true spirit and scope. Further, since numerous modifications and changes will readily occur to those skilled in the art, it is not desired to limit the invention to the exact construction and operation illustrated and described, and accordingly all suitable modifications and equivalents may be resorted to, falling within scope.

What is claimed is:

1. A method of object classification of a computing device comprising:
receiving data;
detecting an object based on said data;
decomposing said object into sub-objects and;
generating parameters based on said sub-objects and connectivities; and
generating objective measures based on at least one of said sub-objects, connectivities and parameters.

2. The method of claim 1 further comprising:
classifying said object based on said objective measures.

3. The method of claim 2 further comprising:
maintaining said parameters, connectivities and sub-objects as a primary multi-dimensional data structure; and
maintaining said objective measures as a secondary multi-dimensional data structure.

4. The method of claim 1 further comprising:
decomposing said sub-objects until each sub-object is a primitive object.

5. The method of claim 1, wherein decomposing is repeated on the sub-objects for n times where n is an integer >1.

6. The method of claim 1 wherein said parameters comprise on one or more of sensory data measures and derived physical measures.

7. The method of claim 6 wherein said sensory data measures comprise one or more of tone, texture and gray value gradient.

8. The method of claim 1 wherein said data is received from a sensing device.

9. The method of claim 1 wherein said data is received from a non-imaging source.

10. The method of claim 1, wherein generating said objective measures include determining an occurrence or co-occurrence of sub-objects, parameters and connectivities.

11. The method of claim 1, generating at least one objective measure further comprising:
linking said parameters into linked parameters; and
generating linked classification measures based on said linked parameters.

12. The method of claim 11, wherein said linking is performed based on connectivities.

13. The method of claim 1 wherein said connectivities include one or more of a spatial, temporal or functional relationship between a plurality of sub-objects.

14. The method of claim 2 wherein said classification is based on a rule based association of said objective measures.

15. The method of claim 1, wherein said generating of said objective measures includes pattern analysis of said parameters.

16. The method of claim 1 further comprising:
detecting an environment object based on said data;
decomposing said environment object into environment sub-objects; and
generating environment parameters based on said environment sub-objects;
wherein generating at least one objective measure is further based on said environment parameters.

17. The method of claim 16 wherein said environment sub-objects and said sub-objects are linked and at least one of said at least one objective measure is based on said linkage between said sub-objects and said environment sub-objects.

18. A computing device for object classification, comprising:
a processor configured to:
receive data;
detect an object within said data;
decompose said object into sub-objects and connectivities;
generate parameter based on said sub-objects and connectivities; and
generate objective measures based on at least one of said sub-objects, connectivities and parameters.

19. The device of claim 18 wherein said processor is further configured to classify said object based on said objective measures.

20. The device of claim 18 wherein said processor is further configured to decompose said sub-objects until each sub-object is a primitive object.

21. The device of claim 18 wherein said processor is further configured to:
link said parameters into linked parameters; and
generate linked classification measures based on said linked parameters.

22. The device of claim 18 wherein said processor is further configured to:
detect an environment object based on said data;
decompose said environment object into environment sub-objects; and
generate environment parameters based on said environment sub-objects;
wherein said processor is configured to generate said objective measures further based on said environment parameters.

23. The method of claim 18 wherein said processor is further configured to:
maintain said parameters, connectivities and sub-objects as a primary multi-dimensional data structure; and
maintain said objective measures as secondary multi-dimensional data structure.

24. The method of claim 23 wherein said processor is further configured to classify said object based on said secondary multi-dimensional data structure.
